(19) United States
(12) Patent Application Publication
(10) Pub. No.: US 2015/0110384 A1
(43) Pub. Date: Apr. 23, 2015

(54) IMAGE INSPECTION METHOD OF DIE TO DATABASE

(71) Applicant: MACRONIX International Co., Ltd., Hsinchu (TW)

(72) Inventors: Tuung Luoh, Hsinchu (TW); Hsiang-Chou Liao, Hsinchu (TW); Ling-Wuu Yang, Hsinchu (TW); Ta-Hone Yang, Hsinchu (TW); Kuang-Chao Chen, Hsinchu (TW)

(73) Assignee: MACRONIX International Co., Ltd., Hsinchu (TW)

(21) Appl. No.: 14/274,177

(22) Filed: May 9, 2014

Related U.S. Application Data
(60) Provisional application No. 61/894,440, filed on Oct. 23, 2013.

(51) Int. Cl. G06T 7/00

(52) U.S. Cl. CPC G06T 7/001
USPC 382/149

(57) ABSTRACT

An image inspection method of die to database is provided, and the positions in the to-be-inspected chips within one wafer may be selected. In the method, a plurality of inspection areas in a plurality of positions in the to-be-inspected chips within a wafer are selected, a plurality of raw images of the inspection areas are obtained, and a plurality of locations of the raw images are then decoded. After that, an image extraction is performed on the raw images to obtain a plurality of image contours. Thereafter, the image contours are compared with a design database of the chip in order to obtain a result of a defect inspection, and execute the same thing in whole wafer.

### CROSS-REFERENCE TO RELATED APPLICATION

This application claims the priority benefits of U.S. provisional application Ser. No. 61/894,440, filed on Oct. 23, 2013. The entirety of the above-mentioned patent application is hereby incorporated by reference herein and made a part of this specification.

### BACKGROUND OF THE INVENTION

1. Field of the Invention

The invention relates to a wafer inspection method, and more particularly, to an image inspection method of die to database (D2DB).

2. Description of Related Art

As line width continue to shrink in an IC manufacturing process, control and monitor of critical dimensions became increasingly important. In semiconductor technologies of a nanometer generation, it is more difficult to accurately inspect defects on a surface structure of a wafer.

At present, an E-beam inspection tool is used to inspect the surface structure of the wafer. However, since an area of the wafer is quite large, only after images of whole wafer are obtained, an e-beam inspection may then be performed one by one on the images. Therefore, it may take months to complete the inspection for single wafer. Moreover, because the line widths of semiconductor devices are quite small, it is possible that data relating to an optical proximity correction (OPC) is inaccurate, resulting in defects only to be found after fabrication of the wafer. The yield of the semiconductor devices in the semiconductor technologies of the nanometer generation can be seriously affects by detects being found after massive production.

Accordingly, it is desired to find an inspection method for obtaining the images and the defects of the wafer in real time.

### SUMMARY OF THE INVENTION

The invention provides an image inspection method of die to database (D2DB), which is capable of accurately obtain a result of an image inspection in real time or off-line.

The invention also provides an image inspection method of die to database, which is capable of quickly obtaining results of inspections to each of the inspection areas in whole wafer.

In an image inspection method of die to database according to the invention, a plurality of inspection areas in positions in the to-be-inspected chips within a wafer are selected, a plurality of raw images of the inspection areas are obtained, and a plurality of locations of the raw images are then decoded. After that, an image extraction is performed on the raw images to obtain a plurality of image contours. Thereafter, the image contours are compared with a design database of the wafer in order to obtain a result of a defect inspection of the to-be-inspected chips within whole wafer.

In an embodiment of the invention, the coordinates of the inspection areas may be reset to minimize an overlapped portion of the inspection areas.

In another image inspection method of die to database according to the invention, a plurality of inspection areas in positions in the to-be-inspected chips within a wafer are selected, a plurality of raw images of the inspection areas are obtained, and a plurality of locations of the raw images are then decoded. Next, the raw images in 1:1 ratio are directly displayed on a design database of the chips according to the physical coordinates, and then the raw images are compared with the design database to perform a defect classification.

In each embodiment of the invention, the step of selecting the inspection areas includes setting areas having a critical dimension lower than a predetermined value in the design database to the inspection areas.

In one embodiment of the invention, the step of selecting the inspection areas includes setting areas over or under a predetermined value to the inspection areas according to a design rule.

In each embodiment of the invention, the step of selecting the inspection areas includes selecting the inspection areas according to a result of a wafer defect inspection previously performed, wherein the detection apparatus includes bright field inspection, dark field inspection, E-beam inspection tool, or other optical scanning tool.

In each embodiment of the invention, the step of obtaining the raw images includes obtaining the raw images by utilizing an E-beam inspection.

In each embodiment of the invention, an apparatus for executing the E-beam inspection includes an E-beam inspection tool, a bright field inspection equipment with a light source having a wavelength of 150 nm to 800 nm, a dark field inspection equipment with a laser light source, or scanning electron microscope review tool.

In each embodiment of the invention, the step of obtaining the raw images further comprises decoding a metafile of the raw images and marking the die positions and the defect coordinates positions correspondent to die corner so as to transfer the raw images into a die database.

In each embodiment of the invention, the step of obtaining the raw images further comprises decoding a filenames of the raw images and marking the die positions and the defect coordinates positions correspondent to die corner so as to transfer the raw images into a die database.

In each embodiment of the invention, the step of obtaining the raw images includes take the wafer printed images according to the known die positions and the defect coordinates positions correspondent to die corner, whereby transferring the known die positions and corresponding images into a die database.

In each embodiment of the invention, the design database includes a GDS file of a source design database, a GDS file of a simulated post-optical proximity correction, or a design database converted from a simulated tool.

In each embodiment of the invention, the step of selecting the inspection areas includes selecting all of the positions in the chips within whole wafer as the inspection areas.

In each embodiment of the invention, before obtaining the raw images of the inspection areas, a die register (i.e. align with some position in each die) is further performed to improve alignment performance before obtaining the raw images of the inspection areas, and an identify position or a virtual die corner is set on to-be-shot positions or to-be-inspection coordinates in different dies such that alignment performance is improved.

Based on above, the invention is capable of directly displaying the raw images on the design database, such that defect information for specific inspection area may be obtained in real time or off-line. Moreover, a more accurate result may be obtained by comparing the raw images with the design database by utilizing the image extraction.

In addition, the invention is capable of quickly obtaining the defect information by directly comparing the raw images with the design database according to the physical coordinates.

It is to be understood that both the foregoing general description and the following detailed description are exemplary, and are not intended to limit the scope of the invention.

### BRIEF DESCRIPTION OF THE DRAWINGS

FIG. 1 is a flowchart of an image inspection method of die to database according to an embodiment of the invention.

FIG. 2A is a schematic view illustrating the raw images being obtained in specific regions according to an embodiment of the invention.

FIG. 2B is an example of FIG. 2A.

FIG. 3A is a schematic view showing a plurality of inspection areas in a wafer.

FIG. 3B is a schematic view of the inspection areas depicted in FIG. 3A being reset.

### DESCRIPTION OF THE EMBODIMENTS

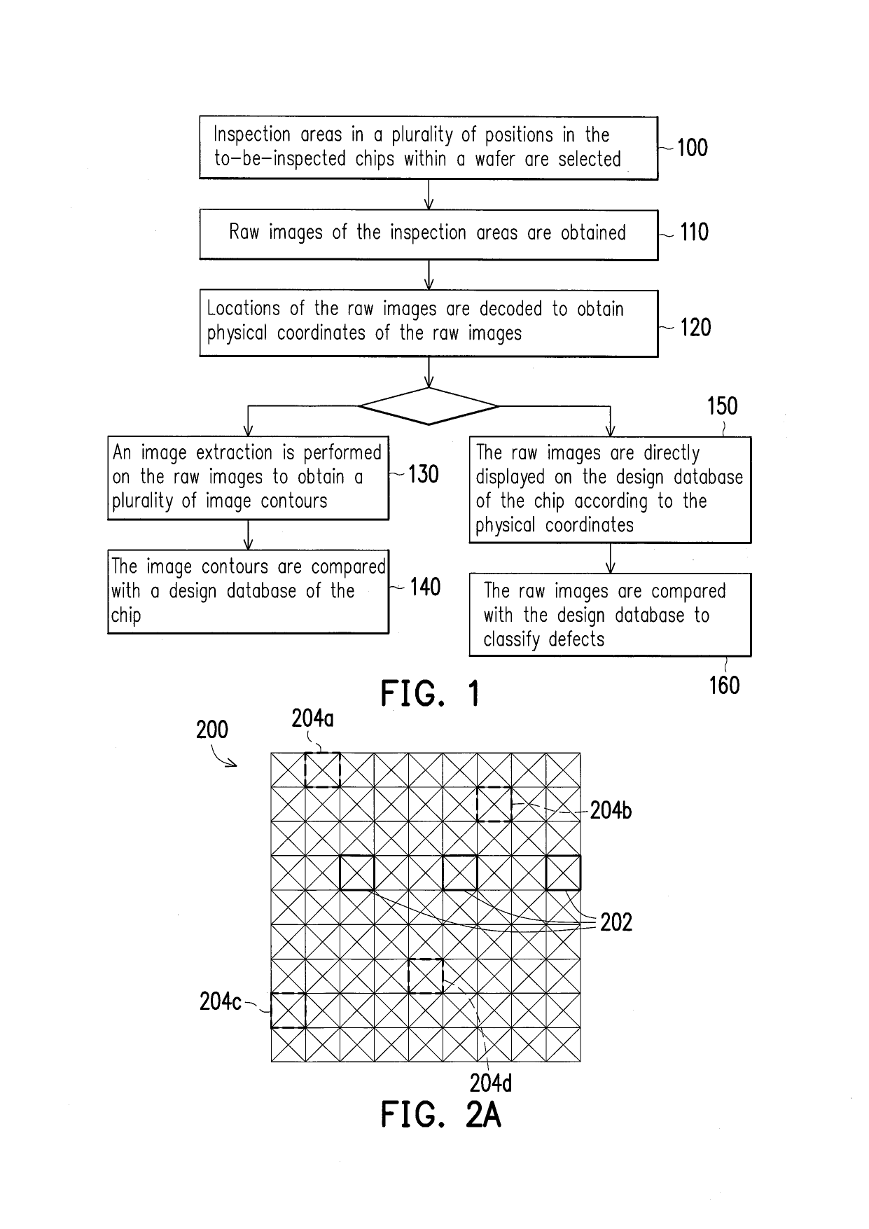

FIG. 1 is a flowchart of an image inspection method of die to database according to an embodiment of the invention.

Referring to FIG. 1, in step 100, inspection areas in a plurality of positions in the to-be-inspected chips within a wafer are selected. The step of selecting the inspection areas may significantly reduce a time taken to perform the entire inspection flow, and known defects and/or unknown defects may also be inspected according to the method of the present embodiment. There are various methods for reducing the inspection areas to be inspected in the present embodiment, such as selecting the areas by performing following steps based on a risk analysis, a pattern density, a design rule, a minimum CD, a pattern uniformity, or a result obtained by inspecting with a KLA apparatus. In addition, the following steps may still be selectively performed on all areas of the whole wafer if necessary.

More specifically, the methods for selecting the inspection areas are as listed below. The first method is to set areas having a critical dimension (CD) lower than a predetermined value in a design database to the inspection areas. The design database includes a GDS file of a source design database, a GDS file of a simulated post-optical proximity correction, or a design database converted from a simulated tool and so on. The second method is to set areas prone to defects to the inspection areas according to an experience rule. The third method is to set areas over a predetermined value or under the predetermined value to the inspection areas according to a design rule. For instance, a lithographic rule checking (LRC), a design rule checking (DRC), a care area may be directly transferred to as a basis for selecting the inspection areas. The fourth method is to select the inspection areas according to a result of a wafer defect inspection previously performed. Therein, the result of the wafer defect inspection refers to a result obtained from an inspection using the KLA apparatus, and a file format thereof is known as “KLARF” (i.e. a KLA result file). The so-called KLARF may be outputted from a multiple scanning with different light sources and resolutions, an optical scanning, or a single scanning with single condition. The methods for selecting the inspection areas may be implemented by using one of the methods only or using two or more of the methods together. Moreover, the method of this embodiment may include selecting all of the positions in the chips within whole wafer as the inspection areas.

Next, proceeding to step 110, raw images of the inspection areas are obtained, and the raw images is obtained by utilizing, for example, an E-beam inspection. An apparatus for executing the E-beam inspection includes an E-beam inspection tool, a bright field inspection equipment with a light source having a wavelength of 150 nm to 800 nm, a dark field inspection equipment with a laser light source, or scanning electron microscope review tool. The raw images obtained by the method may be further decoded a metafile of the raw images and then marked with the die positions and the defect coordinates positions correspondent to die corner while being outputted, whereby transferring the raw images into a die database. Moreover, The raw images obtained by the method may be further decoded a filename of the raw images and then marked the die positions and the defect coordinates positions correspondent to die corner so as to transfer the raw images into the die database. In addition, the method for obtaining the raw images of the inspection areas may include take the wafer printed images according to the known die positions and the defect coordinates positions correspondent to die corner (e.g. the positions of inspection coordinates such as Klarf file), whereby transferring the known die positions and corresponding images into the die database.

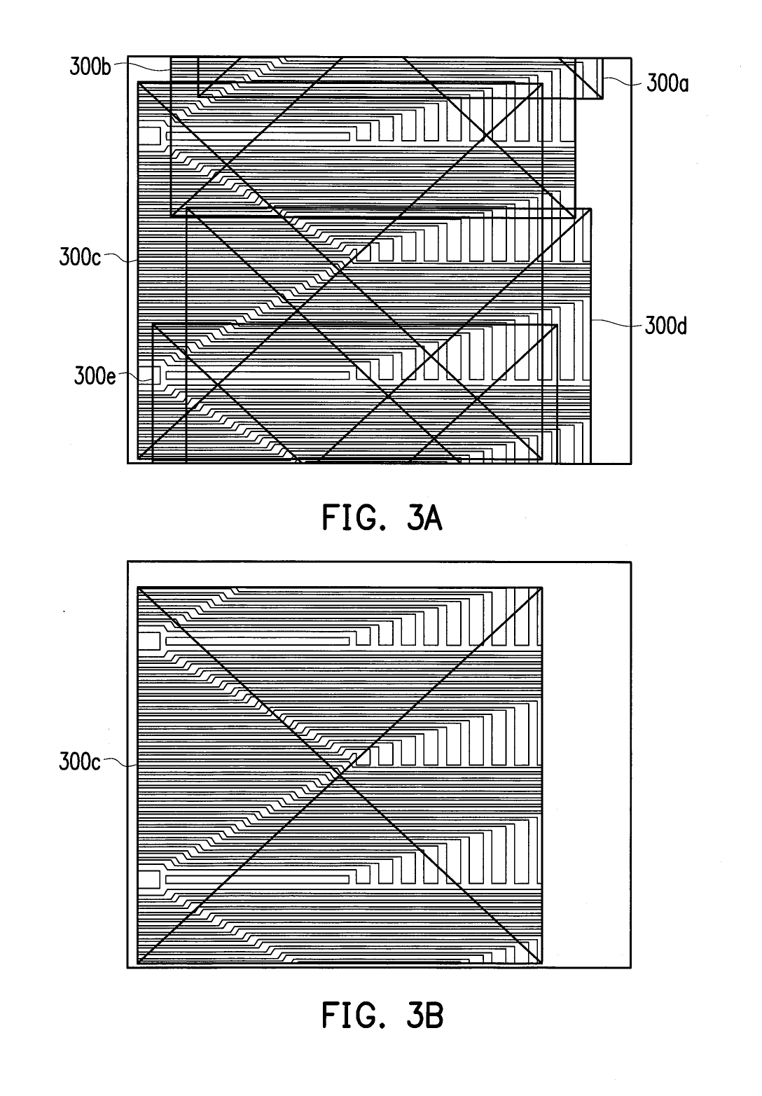

In addition, the coordinates of the inspection areas may be reset to minimize an overlapped portion of the inspection areas. For instance, in case the inspection areas are selected according to the result of the wafer defect inspection (e.g., a KLA inspection), a schematic view as depicted in FIG. 3A is then obtained. FIG. 3A illustrates that there are five inspection areas (300a to 300e) in a chip, however, it is apparently that the inspection areas (300a to 300e) have a number of portions which are overlapping each other. In case an identical portion in the wafer is irradiated by the E-beam for a number of times, the line architecture thereof may be damaged.

Therefore, it is more preferable to avoid the inspection areas from overlapping each other. Accordingly, due to the rule, the overlapped portions among the inspection areas (300a to 300e) are eliminated according to the coordinates thereof wile maintaining the area 300c depicted in FIG. 3B, or the inspection areas (300a to 300e) are reset to the inspection areas having no overlapped portions.

Moreover, before the step 110, for the improvement in alignment performance, it may perform a die register (i.e. align with some position in each die), or set an easy to identify position or a virtual die corner on to-be-shot positions or to-be-inspection coordinates in different dies.

Next, in step 120, locations of the raw images are decoded to obtain physical coordinates of the raw images. A result of this step may be outputted from the apparatus for executing the E-beam inspection as identical to that in step 110. In other words, after the E-beam inspection and take raw images to LRC, Care area or Risk area, the results are transferred into GDS coordinates in proportion to areas inspected by the inspection equipment, and the GDS coordinates are then matched with corresponding design layout (scale 1:1).

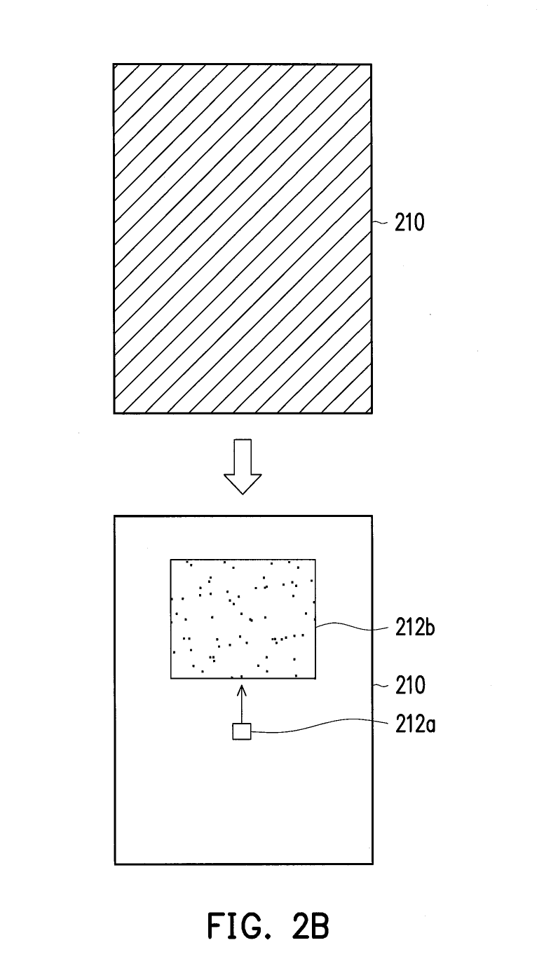

FIG. 2A shows a specific region 200 presuming as one matrix. A shoot and record process is then performed on the raw images based on one image in field of view (FOV). It is assumed that areas 202 corresponded to the same line architecture are high pattern density areas, so that the areas 202 may be selected as the inspection areas. Further, areas (204a to 204d) with a CD value lower than a specific value may also be set to the inspection areas. Accordingly, an inspection flow originally performed on all of image data is now simplified to inspect seven areas (202, 204a to 204d) therein, such that the time required may be significantly reduced. Afterwards, the obtained raw images may be transferred into a schematic diagram corresponding to chip database, and the inspected images may be recorded on a comparison report of the chip database during this process.

FIG. 2B shows a practical example of FIG. 2A. It is assumed that the originally-inspected region (refer to upper diagram marked with diagonals) in whole chip 210 has an area of 0.24 cm². After the efficient analysis, a risky care area (refer to lower diagram) may be transferred into a plurality of polygons 212a with various sizes. In the magnified polygon 212b, there are defects therein, and the minimum unit is a field of view (FOV) of one shoot. Since the area of the polygon 212a is 0.0000225 cm², the area is decreased about ten thousand times than that of the originally-inspected region, such that the inspection time required may be significantly reduced.

Thereafter, steps 130 and 150 may be performed alternatively.

In step 130, an image extraction is performed on the raw images to obtain a plurality of image contours. The image extraction is capable of extracting a contour of a 2D image. Methods for performing the image extraction includes an edge contour extraction, a self-affine mapping system, a self-affine snake model, an active contour model, an expectation-maximisation algorithm, a principal component analysis, a level sets algorithm or a Monte Carlo techniques. Moreover, the image extraction may be of an on-line extraction, which is capable of accomplishing a process in real time through a fast algorithm as well as indicating the coordinates.

After step 130, the image contours are compared with a design database of the wafer in order to obtain a result of a defect inspection in real time (step 140). Since the image contours are directly displayed on a graph of the design database, the differences between the image contours and the design databases are immediately and accurately contrasted to get the defects directly and then classify the same in real time. In the present embodiment, systematic defects may be repeatedly obtained from the results of the inspections to different dies/chips located in the wafer.

Furthermore, in case step 150 is implemented after step 120, the raw images are directly displayed on the design database of the wafer according to the physical coordinates.

Next, in step 160, the raw images are compared with the design database to classify defects. Based on the off-line comparisons in steps 150 and 160, many of the defects may be found in the same image since a FOV is large (3 μm to 50 μm) and a resolution is preferable. Also, there is no problem such as poor image quality and poor contrast ratio, and an inaccuracy at intersection of the images are also resolved. In the present embodiment, the comparison may be directly done by eyes in step 160, but the invention is not limited thereto.

In addition, based on different case, it may change foregoing steps of the invention into following steps.

First step: to select wafer, wherein the selected wafer includes FEM or PWQ wafer or normal wafer, for example.

Second step: to select the focus area. Please refer to the step 100 in FIG. 1. For example, it is optionally to select the inspection areas by Risk Analysis Input (ex. LRC, DRC, etc.) Moreover, it is possible to select the inspection areas by Risk Pattern Specified such as pattern search or similarity. Furthermore, the inspection areas may be selected by care area reduction or from KLA BF or DF.

Third step: to use KLA BF or DF or e Beam tool to inspect and take raw images.

Fourth step: to use e beam optimize.

Fifth step: to load wafer/take raw image according identified areas in the second step.

Sixth step: to decode the image on layout.

Seventh step: to image extraction on layout.

Eighth step: to compare the contour differences vs. design target, every 0.0001˜0.01 um measure 1 time (depend on select).

Ninth step: to output the line or space, line end, “max”, “min”, average, 3 sigma, target, bias, bias target, etc. to design target, LER, or LWR. After that, the threshold condition is set to classify the defects into bridge or open types by degree. Hence, the classify results are output.

Note that one algorithm to avoid the raw Image interface induce error will be exclude to disable it.

In summary, the invention is capable of directly displaying E-beam images on the database to provide the coordinates for alignments. Therefore, defect information may be obtained from specific target areas in the surface structure in real time or off-line, so as to be quickly compared with standard images.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An image inspection method of die to database, comprising:
selecting a plurality of inspection areas in a plurality of positions in to-be-inspected chips within a wafer;
obtaining a plurality of raw images of the inspection areas;
decoding a plurality of locations of the raw images;
performing an image extraction on the raw images to obtain a plurality of image contours; and
comparing the image contours with a design database of the wafer to obtain a result of a defect inspection of the positions in the to-be-inspected chips within the wafer.

2. The image inspection method of die to database of claim 1, wherein before obtaining the raw images of the inspection areas, further comprising: resetting a plurality of coordinates of the inspection areas to minimize an overlapped portion of the inspection areas.

3. The image inspection method of die to database of claim 1, wherein the step of selecting the inspection areas comprises setting areas having a critical dimension lower than a predetermined value in the design database to the inspection areas.

4. The image inspection method of die to database of claim 1, wherein the step of selecting the inspection areas comprises setting areas over or under a predetermined value to the inspection areas according to a design rule.

5. The image inspection method of die to database of claim 1, wherein the step of selecting the inspection areas comprises selecting the inspection areas according to a result of a wafer defect inspection previously performed.

6. The image inspection method of die to database of claim 1, wherein the step of obtaining the raw images comprises obtaining the raw images by utilizing an E-beam inspection.

7. The image inspection method of die to database of claim 6, wherein an apparatus for executing the E-beam inspection comprises an E-beam inspection tool, a bright field inspection equipment with a light source having a wavelength of 150 nm to 800 nm, a dark field inspection equipment with a laser light source, or a scanning electron microscope review tool.

8. The image inspection method of die to database of claim 1, wherein the step of obtaining the raw images further comprises decoding a metafile of the raw images and marking a plurality die positions and a plurality of defect coordinates positions correspondent to die corner.

9. The image inspection method of die to database of claim 1, wherein the step of obtaining the raw images further comprises decoding a filename of the raw images and marking a plurality die positions and a plurality of defect coordinates positions correspondent to die corner.

10. The image inspection method of die to database of claim 1, wherein the step of obtaining the raw images comprises:
shooting a plurality of known die positions and a plurality of defect coordinates positions correspondent to die corner; and
transferring the known die positions and a plurality of corresponding images into a die database.

11. The image inspection method of die to database of claim 1, wherein the design database comprises a GDS file of a source design database, a GDS file of a simulated post-optical proximity correction (post-OPC), or a design database converted from a simulated tool.

12. The image inspection method of die to database of claim 1, wherein the step of selecting the inspection areas comprises selecting all of the positions in the chips within whole wafer as the inspection areas.

13. The image inspection method of die to database of claim 1, wherein before obtaining the raw images of the inspection areas, further comprising performing a die register to improve alignment performance.

14. The image inspection method of die to database of claim 1, wherein before obtaining the raw images of the inspection areas, further comprising:
setting an identify position on to-be-shot positions or to-be-inspection coordinates in different dies such that alignment performance is improved, and setting a virtual die corner on to-be-shot positions or to-be-inspection coordinates in different dies such that alignment performance is improved.

15. An image inspection method of die to database, comprising:
selecting a plurality of inspection areas in a plurality of positions in to-be-inspected chips within a wafer;
obtaining a plurality of raw images of the inspection areas;
decoding a plurality of locations of the raw images to obtain physical coordinates of the raw images;
directly displaying the raw images on a design database of the wafer according to the physical coordinates; and
classifying defects by comparing the raw images with the design database.

16. The image inspection method of die to database of claim 15, wherein the step of selecting the inspection areas comprises setting areas having a critical dimension lower than a predetermined value in the design database to the inspection areas.

17. The image inspection method of die to database of claim 15, wherein the step of selecting the inspection areas comprises setting areas over or under a predetermined value to the inspection areas according to a design rule.

18. The image inspection method of die to database of claim 15, wherein the step of obtaining the raw images comprises obtaining the raw images by utilizing an E-beam inspection.

19. The image inspection method of die to database of claim 15, wherein an apparatus for executing the E-beam inspection comprises an E-beam inspection tool, a bright field inspection equipment with a light source having a wavelength of 150 nm to 800 nm, a dark field inspection equipment with a laser light source, or a scanning electron microscope review tool.

20. The image inspection method of die to database of claim 15, wherein the step of obtaining the raw images further comprises decoding a metafile of the raw images and marking a plurality die positions and a plurality of defect coordinates positions correspondent to die corner.

21. The image inspection method of die to database of claim 15, wherein the step of obtaining the raw images further comprises decoding a filename of the raw images and marking a plurality die positions and a plurality of defect coordinates positions correspondent to die corner.

22. The image inspection method of die to database of claim 15, wherein the step of obtaining the raw images comprises:
shooting a plurality of known die positions and a plurality of defect coordinates positions correspondent to die corner; and
transferring the known die positions and a plurality of corresponding images into a die database.

23. The image inspection method of die to database of claim 15, wherein the design database comprises a GDS file of a source design database, a GDS file of a simulated post-optical proximity correction (post-OPC), or a design database converted from a simulated tool.

24. The image inspection method of die to database of claim 15, wherein the step of selecting the inspection areas comprises selecting all of the positions in the chips within whole wafer as the inspection areas.

25. The image inspection method of die to database of claim 15, wherein before obtaining the raw images of the inspection areas, further comprising performing a die register to improve alignment performance;
setting an identify position on to-be-shot positions or to-be-inspection coordinates in different dies such that alignment performance is improved; and
setting a virtual die corner on to-be-shot positions or to-be-inspection coordinates in different dies such that alignment performance is improved.
